(19) United States
(12) Patent Application Publication
(10) Pub. No.: US 2005/0143106 A1
(43) Pub. Date: Jun. 30, 2005

(54) System and method for group messaging and content distribution in Short Message Service

(76) Inventors: Tony Yau Kit Chan, Sunnyvale, CA (US); Justin Hyun-Jun Min, San Mateo, CA (US); Priscilla M. Lu, San Carlos, CA (US)

Correspondence Address: IPSG, P.C., P.O. BOX 700640, SAN JOSE, CA, 95170-0640, US

(21) Appl. No.: 10/995,956

(22) Filed: Nov. 22, 2004

Related U.S. Application Data
(60) Provisional application No. 60/577,406, filed on Jun. 3, 2004.
(60) Provisional application No. 60/524,120, filed on Nov. 21, 2003.

(51) Int. Cl. H04Q 7/20

(52) U.S. Cl. 455/466; 455/412.1

(57) ABSTRACT

A mobile messaging platform for communicating among a plurality of wireless devices comprises at least one gateway configured to communicate with mobile devices and to forward communication over a network. A server containing content is coupled over the network to the gateway, and adapted to receive calls from at least one mobile device to forward content to one or more parties. In one aspect, the mobile devices include cellular telephones, and the content includes rich media. In another aspect, the content includes ring tones, wall paper, mobile games, phone applications and more complex programs and games. Advantages of the invention include the ability to communicate rich content to other users including ring tones, wall paper, mobile games, phone applications and even more complex programs, games and other content.

### RELATED APPLICATIONS

This application claims priority to U.S. Prov. No. 60/577,406 filed Jun. 3, 2004 and U.S. Prov. No. 60/524,120 filed Nov. 21, 2003, incorporated herein by reference

### FIELD

The present invention relates to wireless communication and, more particularly, to a system and method for efficiently handling group messaging in Short Message Service (SMS).

### BACKGROUND

Mobile communication devices are becoming ever more popular. Initially, people primarily used cell phones to call one another, but then additional technologies were added to improve communications. For example, cells phones now include something called a Short Message Service (SMS), and other devices even include the ability to send and receive e-mail. However, since these devices are typically small and compact, they don't have full keyboards, disk drive storage or other features having bulky space requirements.

SMS provides the ability to send and receive messages using wireless communication devices. It is an alternative to voice communication over wireless communication devices, especially for silent, private or very brief communications. SMS was first introduced in 1991 in the Global System for Mobile Communications system (GSM) as a simple store and forward messaging system. It is now supported by a majority of other digital wireless communication systems, including those based on Time Division Multiple Access (TDMA) and Code Division Multiple Access (CDMA) protocols. In connection therewith, various domestic and international standards have been established including, Advanced Mobile Phone Service (AMPS), Interim Standard 95 (IS-95) and Third Generation (3G).

Since SMS is a store and forward system, the messages are not sent directly from senders to recipients, but pass through a Short Message Service Center (SMSC). Each message can contain up to 160 alphanumeric characters. Some non-text formats, such as binary, are also supported for specialized uses such as ring tones, images and videos.

Although text-to-text messages were the initial offering, new applications are being added quickly. For example, short news and stock market quotes can be provided upon request. Messages can also inform users if they have a pending voice mail, email message or appointment. Users can also send notes to friends about dinner reservations, or buy goods and services.

One common usage is user-to-user messaging, where a sender sends an SMS message to recipient, who can then choose to respond to the message by sending a reply to the sender. This user-to-user model work well for one-to-one communications, but not for one-to-many or many-to-one communications. In the latter cases, the current SMS implementations require the SMS client application in the sender wireless device to first duplicate copies of the same message. The number of copies is based on the number of intended recipients. Next, the SMS client application sends each copy of the message separately to the SMSC. The SMSC stores the messages and forwards each to its intended recipient when polled by the recipient. When the recipients reply to the sender, the sender is forced to separately read each individual reply.

There are several disadvantages of such a system. For example, duplicate copies of message are transmitted from the wireless device to SMSC, which takes up bandwidth resources. Also, precious storage is required in the SMSC for each copy of the message. Further, the sender has to read each recipient's reply individually, based on the message queue in the SMSC. Moreover, the sender cannot read all the replies to a given message in sequence, as replies to other messages could be intermingled in the message queue.

With more advanced wireless communication devices, Multimedia Message Service (MMS) is set to succeed SMS as the next generation wireless service in the mobile data communication world. However, MMS has the limitation that communication is limited to one sender and one recipient. Hence, there is a present need to provide a more effective and efficient method for handling group communication in SMS and next generation MMS.

There also exists a present need to improve complex wireless communication and content sharing and distribution. For example, today, mobile phone content like ring tones, wall papers, mobile games, phone applications can only be downloaded by users browsing a web site from the phone or from a computer. A user typically enters a phone number and the web site will then send the content. There is no way to “forward” content to friends and peers.

Consequently, there are needed further advancements and features to enhance the ability of users to communicate with one another and send and receive complex messages containing rich content and even programs.

### SUMMARY

The present invention relates to wireless communication and, more particularly, to a system and method for efficiently handling group messaging and content distribution with mobile communication devices.

An exemplary embodiment of a mobile messaging platform for communicating among a plurality of wireless devices comprises at least one gateway configured to communicate with mobile devices and to forward communication over a network. A server containing content is coupled over the network to the gateway, and adapted to receive calls from at least one mobile device to forward content to one or more parties. In one aspect, the mobile devices include cellular telephones, and the content includes rich media. In another aspect, the content includes ring tones, wall paper, mobile games, phone applications and more complex programs and games. In one aspect, the content can be distributed to multiple parties simultaneously similar to sending a message to multiple parties.

An exemplary embodiment of the invention includes the ability of mobile device users to forward group content to other users, which may be mobile device users or computer users. A server includes software that supports the advanced group features described below.

Advantages of the invention include the ability to communicate rich content to other users including ring tones, wall paper, mobile games, phone applications and even more complex programs, games and other content.

### DESCRIPTION OF THE DRAWINGS

The foregoing and other features, aspects, and advantages will become more apparent from the following detailed description when read in conjunction with the following drawings.

FIG. 1 is a diagram illustrating a network setup, in accordance with one embodiment of the present invention.

FIG. 2 illustrates a server architecture demonstrating the message flow in accordance with one embodiment of the present invention.

FIG. 3 illustrates one example of a manner in which a local server of the present invention communicates with a client.

FIG. 4A-B is a flowchart illustrating one approach of processing a send message request in accordance with the present invention.

FIG. 5 is a flowchart illustrating one approach of processing a read message request in accordance with the present invention.

FIG. 6 is a flowchart illustrating one approach of processing a notify sender request in accordance with the present invention.

FIG. 7 is a flowchart illustrating one approach of processing a notify recipient request in accordance with the present invention

FIG. 8 is a network diagram illustrating the setup of a global server, in accordance with one embodiment of the present invention.

FIG. 9 illustrates one example of a manner in which a global server communicates with multiple local servers and clients, in accordance with one embodiment of the present invention.

FIG. 10 is a flow chart illustrating one approach of forwarding a message to local server by a global server, in accordance with one embodiment of the present invention.

FIG. 11 is a flowchart illustrating one approach of processing a content notification message to a second party, in accordance with one embodiment of the present invention.

### DETAILED DESCRIPTION

The invention is described with reference to specific architectures and protocols. Those skilled in the art will recognize that the description is for illustration and to provide the best mode of practicing the invention. Described herein is an invention relating to wireless communication and, more particularly, to a system and method for Short Message Service (SMS) messaging in a group context. While an exemplary embodiment of the present invention is described below within the context of a wireless communication environment, and with respect to SMS messages, it will readily be appreciated by those skilled in the art that the present invention may find applications in other environments, such as Internet communication and Multimedia messages.

There are many usage models for SMS, ranging from social message passing to coordination for enterprise resource planning. One common usage model involves a group of users communicating with each other using SMS. For example, such a model encompasses situations such as mothers confirming a child play group meeting, or a secretary arranging a business meeting among different managers.

The present invention enables such groups of users to communicate with each other more effectively and efficiently. It eliminates the need for the sender's SMS client to make multiple copies of a message and send them to the SMSC. Using the present invention, the sender's SMS client sends only a single copy of the message to SMSC. This saves processing by the sender's wireless device, and network bandwidth between the wireless device and SMSC. Furthermore, the SMSC needs to store only a single copy of the message. Moreover, the present invention has the capability to compile replies from all the recipients before notifying the sender. This enables the sender to read all the replies at once, rather than individually, when a recipient replies.

In one embodiment, the present invention comprises a Multimedia Sharing Group (MSG) server residing at the service provider network, and a MSG client application at the user's wireless device. Service providers, such as but not limited to, telecommunication carriers and operators, and Internet-based SMS providers, can benefit from using embodiments of the present invention.

A. Local MSG Server

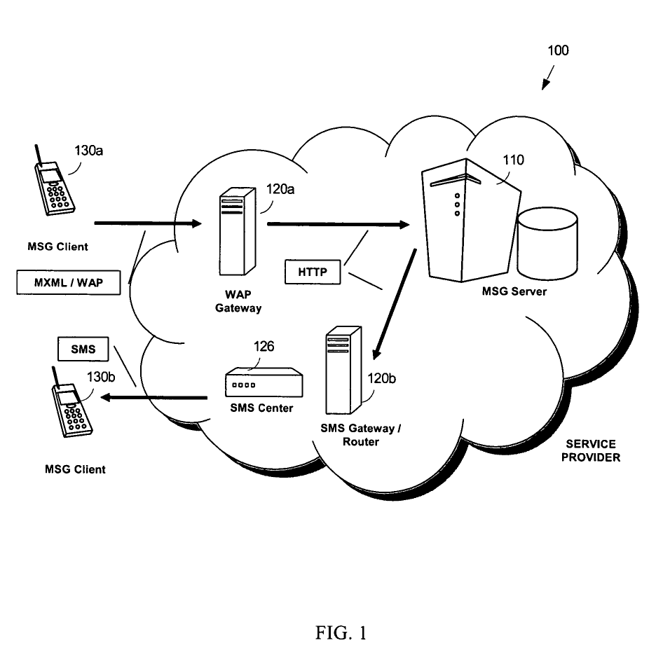

FIG. 1 is a diagram illustrating a network setup 100, in accordance with one embodiment of the present invention. The network 100 includes a MSG server 110 and a number of gateways 120a-120b and clients 130a-130b. The MSG Server 110 is a set of servers that provide MSG functionality via the gateways. The clients 130a-130b are depicted at cell phones, but can be any type of mobile devices including voice, e-mail devices and other types of devices.

The Wireless Application Protocol (WAP) Gateway/Push Proxy 120a translates the WAP protocol stack to Hypertext Transfer Protocol (HTTP)/Transmission Control Protocol/Internet Protocol (TCP/IP) and vice versa. It also provides push capabilities to wireless clients via the WAP Push Access Protocol.

The SMS Gateway/Router 120b are servers that provide SMS sending and routing capabilities. The SMS Gateway/Router support various protocols for SMS message submission. These include HTTP and Short Message Peer to Peer (SMPP). A Short Message Service Center (SMSC) 126 provides SMS store and forward functions.

B. MSG Server Architecture

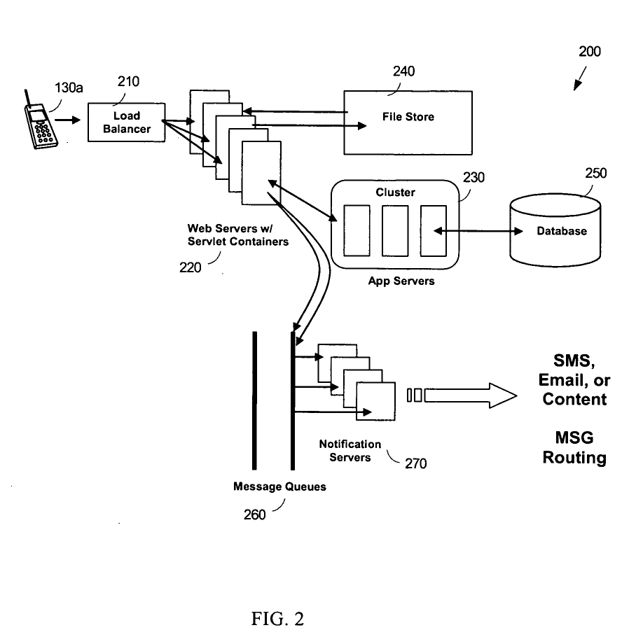

FIG. 2 illustrates the MSG server architecture, in accordance with one embodiment of the present invention. The architecture comprises the following elements:

FIG. 2 illustrates the MSG server architecture 200 demonstrating the message flow in accordance with one embodiment of the present invention. When a first party mobile device 130a user wants to communicate with one or more second party mobile devices, e.g. 130b-130n, the MSG server controls the communication.

A Load Balancer 210 is an optimal hardware component or web server configured as a proxy server that balances requests across multiple servers. It allows the addition and removal of servers transparently to the system to increase or decrease server capacity of the system.

Web Servers/Servlet Containers 220 are the first contact points for a user's MSG client application. These servers and servlet containers perform the initial processing for handling MSG client requests. They delegate any database management and notification tasks to other components of the MSG system. The web server and servlets handle the bulk of file transfer tasks.

Application Servers 230 serve as a memory cache of MSG group information. In addition, they provide the underlying application services, such as transactions, persistence and clustering to the bulk of the MSG server application.

File Store 240 contains messages. Messages are stored in raw form for easy transfer. Meta information about the messages is stored in the file system along with the message or in the database. The file store may be a set of RAID disk arrays.

Database 250 serves as the central repository for user information. It contains billing information, such as the usage of individual MSG users. It also records device information, which is used to customize messages for optimal rendering on each user's wireless device.

Messaging Queues 260. The MSG server uses messaging queues to separate send/reply message from notification message. The messaging queues implement a publish/subscribe mechanism, which allows a variable number of servers to handle delivery of notification requests.

Notification Servers 270 are multi-threaded servers that identify incoming notification message requests from the messaging queues. The servers fulfill the requests by forwarding the notification to the users. Various transports can be used, depending on the user's preference, including Simple Mail Transfer Protocol (SMTP), SMS or MMS.

C. Database and File System

The MSG server application uses a database and file system to store information such as users, messages and billing data. In one embodiment, the database contains the following features. In other embodiments, the invention can contain one or more of these features.
(a) User preferences enables a user to define preference settings for items such as authentication information, notification frequency and device attributes.
(b) Billing data and usage information for each user is stored in Call Data Records (CDRs). This information is periodically queried by the billing system of the service provider.
(c) Device information database contains a library of device information used to identify features and limitations of the various client devices.
(d) System configuration information for all components in the MSG system is stored in the database. This provides means for centralized control and configuration of the various MSG server components.
(e) MSG client state is maintained by the server to identify the status of the users with respect to messages and notification. For example, the number of messages pending for reply and the number of messages replied to by user.
(f) MSG server notification state. The MSG servers can be deployed in a global context, such as across different service providers. The MSG server notification state provides information such as, whether or not a message is routed outside the local infrastructure, and whether or not the global MSG server has accepted delivery responsibility for a message.

The File System contains the actual messages. Messages are stored in directories for easy access and reclamation of storage. The storage is partitioned into volumes for easy addition of new disks as storage needs grow. Volume and directory information are recorded in the database so that migration from one volume to another can be done transparently to the application.

D. MSG Server-Client Protocol

The present invention defines and uses MXML (Mobile Extensible Markup Language) as the communication protocol between an MSG server and an MSG client.

In one embodiment, the MXML includes of the following elements.
(a) MXML Language, which is an application of XML 1.0 (Extensible Markup Language).
(b) MXML Encoding. The MXML-Encoding encodes binary data in MXML Language text form.
(c) MXML Compression serves the function of compressing data sent and decompressing data received. This minimizes the amount of data to be transmitted.

The MXML protocol is designed for portability across different platforms. It enables the MSG client to work transparently with different wireless operating systems and diverse programming languages.

When a user engages an SMS service, the MSG client sends an operation request to the MSG server. The MSG client first embeds information, such as user data and operation request, in MXML Language. If there is any binary data, such as multimedia data, it will be encoded into MXML Language by the MXML Encoding. Next, the MSG client compresses the data in MXML Language using MXML compression. The client sends the compressed data to the MSG server, using the underlying wireless communication protocol, such as HTTP or WAP.

Upon receiving an MXML request, the MSG server decompresses the data using MXML Compression. It then decodes the data into MXML Language and processes the data. If the server needs to send a reply back to the client, it then encodes all the binary data in MXML Language, compresses and sends the data to the MSG client.

E. Communication Process Between a MSG Server and Client

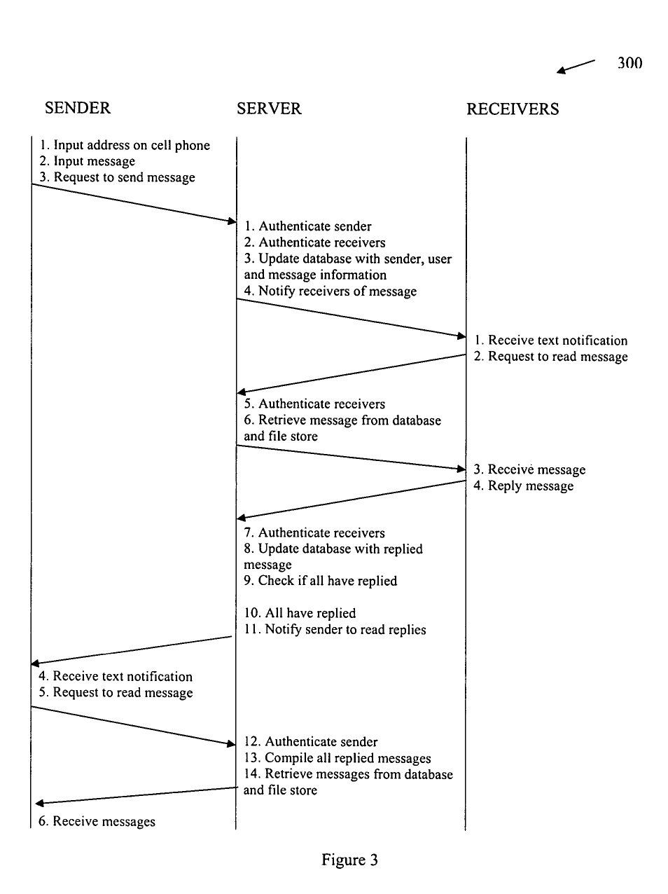

An example of a manner in which a local MSG server communicates with an MSG client is illustrated in FIG. 3. In this simplified environment, a sender sends a message to multiple recipients or a group of users, and expects a reply from each of the recipients. The MSG server processes the sender's message and forwards it to the relevant recipients. When all the recipients have replied, the MSG server compiles the replies and notifies the sender that the replies are ready for viewing.

In another embodiment, the sender can view the messages whenever he decides to, even when not all the recipients have replied. Alternatively, the MSG server can be configured to notify the sender to view the replies at a certain time of the day or some time prior to an event. For example, if the sender uses SMS to set up an appointment with a group of users, the MSG server may send a notification to the sender to view the SMS replies two hours before the appointment.

The MSG server can also check to see if a user's device is MSG enabled, and provide the necessary means for the MSG client application to be downloaded to the device. In addition, the device information in the database enables the MSG server to recognize features of a wireless device. For example, if a wireless device is SMS enabled only and not Java 2 Platform Micro Edition (J2ME) enabled, the MSG server sends an SMS message with message text in the body.

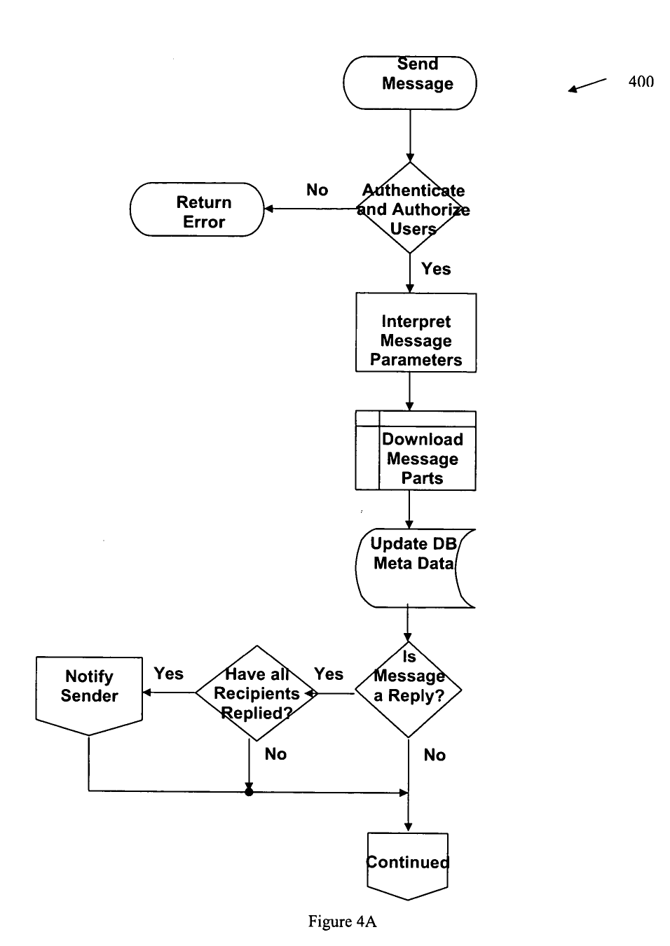

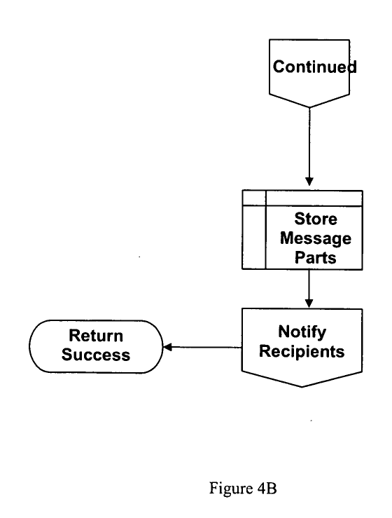

FIGS. 4A-B is a flowchart 400 illustrating one approach of processing a send message request by the MSG server. When a user sends a message, the MSG server first authenticates and authorizes the user. Subsequently, it interprets the message parameters and downloads the message parts to a temporary storage. The information retrieved from the message, such as sender-recipient information, is then updated in the database. The MSG server checks to see if the message is a reply. If it is, the server proceeds to count the total replies from the group of users. If the reply completes the total count, it so notifies the sender. If the MSG server checks that the message is not a reply, the user is recognized as a sender. The MSG server will store the message parts in file store and notify the intended recipients.

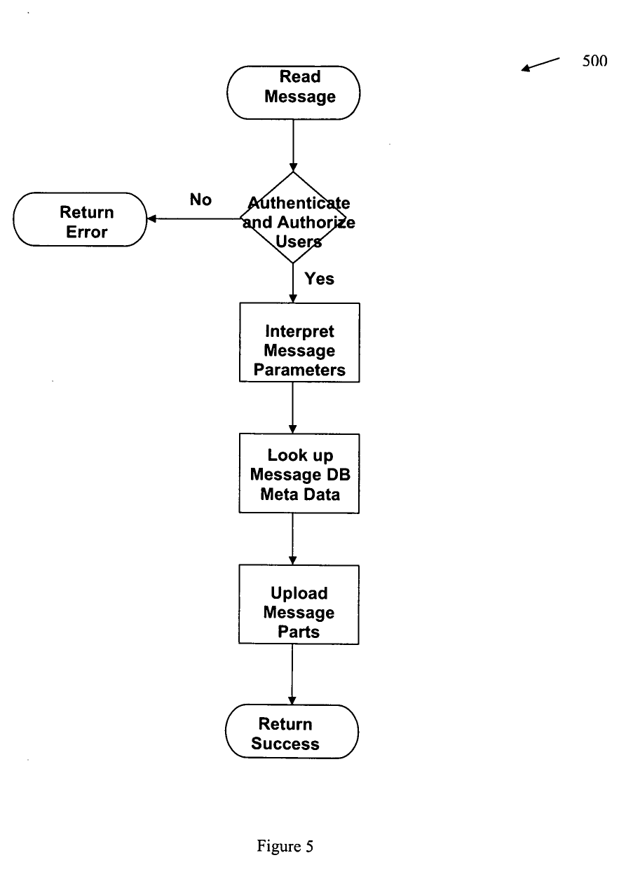

FIG. 5 is a flowchart 500 illustrating one approach of processing a read message request by the MSG server. It comprises the steps of first authenticating and authorizing the user. Next, the server reads the message parameters. Based on the information in the message parameters the server looks up the message database to locate the message. It then uploads the message to the user.

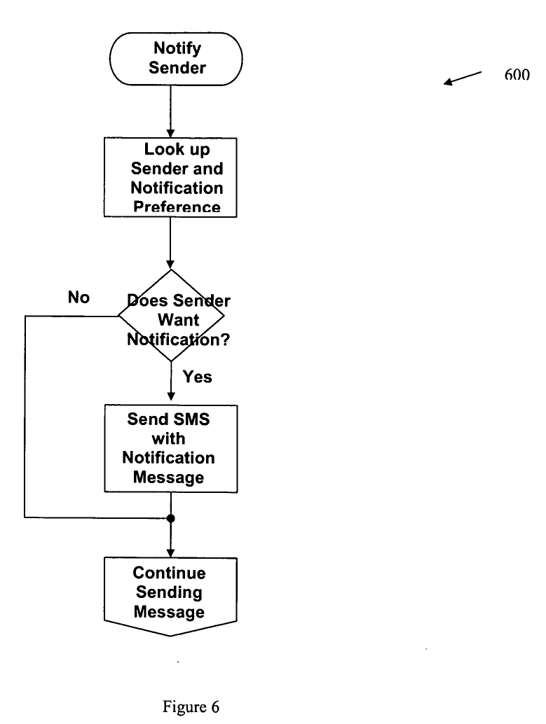

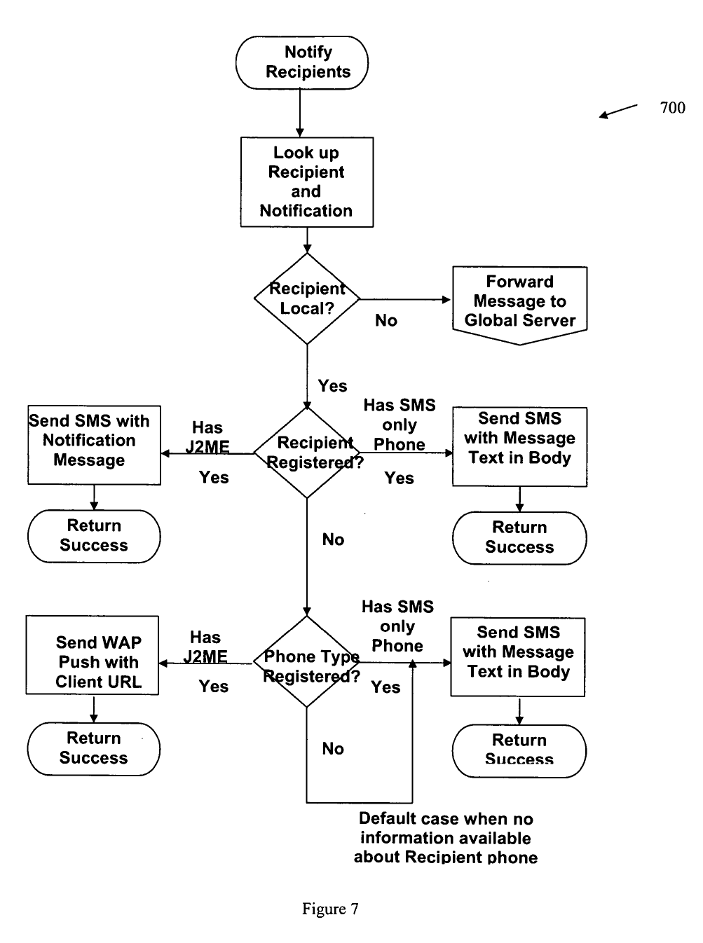

FIGS. 6 and 7 are flowcharts 600 and 700 illustrating one approach of processing a notify sender and recipient request by the MSG server, respectively. The process for notifying a recipient is more complex than a sender because the present invention caters for SMS messaging across different service providers. Therefore, there is a need to determine whether or not the recipient has the same service provider as the sender. If not, the MSG server will then forward the message to a MSG Global Server, which routes the messages to a different provider engaged by the recipient.

F. Global MSG Server

The present invention enables the MSG server to be setup in a global context, such as with different service providers, or with service providers located in different geographical locations.

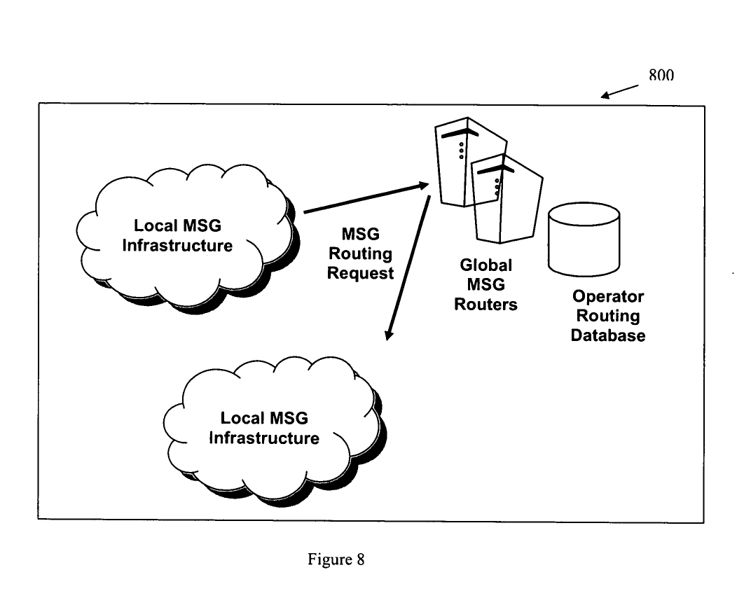

FIG. 8 depicts a network setup of a global MSG server 800, in accordance with one embodiment of the present invention. The network setup includes the following components.
(a) Global MSG Routers perform the routing logic of forwarding messages between different service providers. The routers consult the Operator Routing Database to identify the service provider that services the recipients of the message. Once the service provider is identified, the router attempts to forward the message to the local MSG server of the service provider.
(b) Operator Routing Database is a database that maps portions of contact information, such as a cell phone number, to the corresponding service provider. For example, the country code identifies the geographical location of the service provider. In some countries, the first three digits of the cell phone number is unique for each service provider.

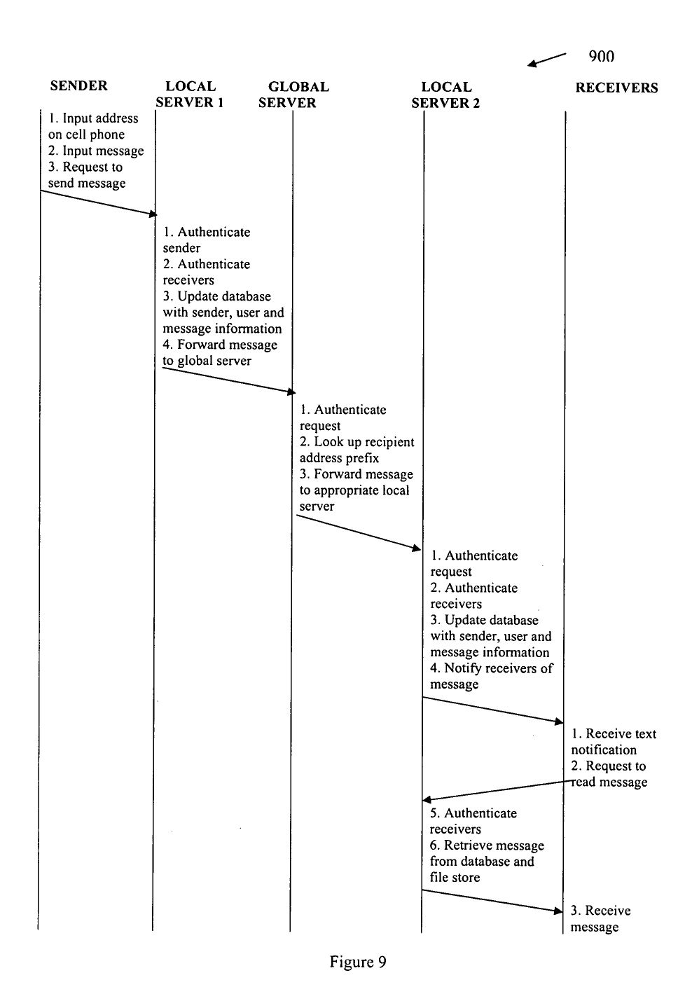

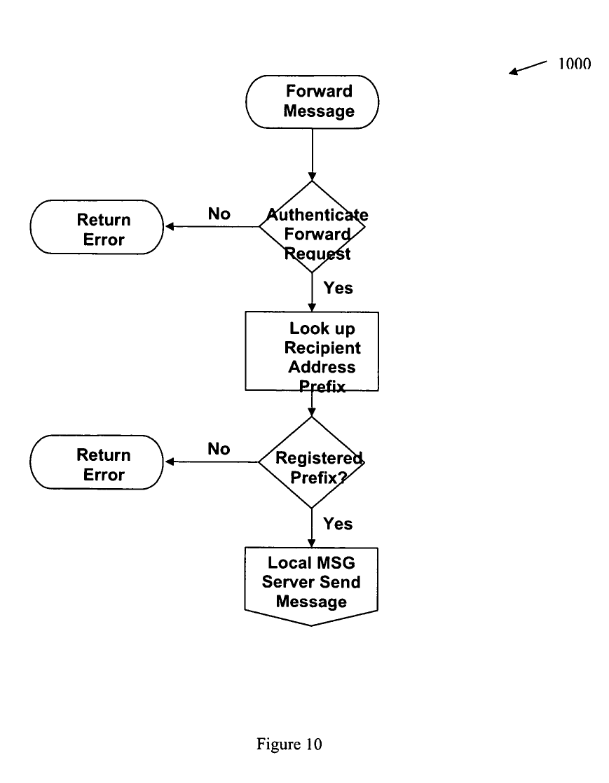

FIG. 9 further illustrates one example of a manner in which a global MSG server communicates with multiple local MSG servers and MSG clients. The communication process includes the step of forwarding message to a global MSG server that routes the message to the appropriate local MSG server of the recipients' service providers.

G. Sorting Algorithms in the MSG Client Application

The present invention includes a method and system for sorting messages and user addresses and groups in the MSG client application.

Two basic functions Ωₖ and Φₖ are used, which always return a number between 0 and 1 inclusive regardless of the parameters.

$${Ω}_{k} ( n ) = \{ \begin{matrix}1 - \frac{1 - k}{n} , & if n > 0 \\ 0 , & if n = 0\end{matrix} \} ,$$

where n is a non-negative integer, and k is a real number between 0 and 1.
Ωₖ(n) is an increasing function from 0 to 1.
Ωₖ(0)=0.Ωₖ(1)=k.Ωₖ(n) increases slowly as n increases. When n approaches ∞, Ωₖ(n) approaches 1.

$${Φ}_{k} ( n ) = \{ \begin{matrix}1 - \frac{n}{k} , & if n < k \\ 0 , & if n \geq k\end{matrix} \} ,$$
where n is a non-negative integer, and k is a positive integer.
Φₖ(n) is a decreasing function from 1 to 0.
Φₖ(0)=1. As n increases, Φₖ(n) decreases gradually. When n≧k, Φₖ(n)=0.

In one embodiment, the messages can be sorted based on the following message sorting priority, Pₘ
Pₘ=m₁w₁+m₂w₂+m₃w₃+m₄w₄
where w₁, w₂, w₃ and w₄ are adjustable weights.
m₁ indicates a message originating from the user,

$${m}_{1} = \{ \begin{matrix}1 , & if message originates from the users \\ 0 , & otherwise\end{matrix} \\ {m}_{2} is a reply state of the user , \\ {m}_{2} = \{ \begin{matrix}1 - {m}_{1} , & if user has replied to the message \\ 0 , & otherwise\end{matrix} \\ {m}_{3} is a read state of the user , \\ {m}_{3} = \{ \begin{matrix}1 , if user has read the changed message \\ 0 , if the message has not changed from last \\ read , or the user has not read the changed message .\end{matrix} \\ {m}_{4} is the number of new replies . \\ {m}_{4} = {Ω}_{0.5} ( n )$$
where n is the number of new replies to the message.

Therefore, the messages can be sorted in a priority, which the user can easily manipulate. For example, if the user wants to always read the message with the most number of new replies, w₄, the weight for m₄ the number of new replies can be adjusted to be higher than the other weights.

The MSG client application allows a user (described as “sender” in this section) to sort addresses of users (referred to as “users” in this section) based on the following address sorting priority.
Pᵤ=u₁z₁+u₂z₂+u₃z₃+u₄z₄
where z₁, z₂, z₃ and z₄ are adjustable weights,
u₁ is the recency of the last message to the user,
   u₁=Φ₁₅(n)
where n is the number of days since the sender last sent a message to the user.
u₂ is the frequency of messages originated from the user,
   u₂=Ω_{0.5}(n)
where n is the number of messages received that originated from the user.
u₃ is the frequency of messages with the user as a recipient,
   u₃=Ω_{0.25} (n)
where n is the number of messages received that have the user as one of the recipients.
u₄ is the provisioned state of the user,

$${u}_{4} = \{ \begin{matrix}1 , & if the user has been provisioned \\ 0 , & otherwise \end{matrix}$$

In the above embodiment, the MSG client can sort users' addresses according to the frequency of communication with the user. For example, if the sender frequently sends message to a user, the user's address can be listed at the top of the address book so that the sender can efficiently select the user's address.

Likewise, the MSG client can also sort group addresses. The group address sorting priority function is as follows:
P_{g}=g₁y₁+g₂y₂+g₃y₃
where y₁, y₂, and y₃ are adjustable weights.
g₁ is the recency of group creation
   g₁=Φ₅(n)
where n is the number of days since the group has been created.
g₂ is the frequency of group usage by user,
   g₂=n/nₘₐₓ
where n is the number of messages the user has sent to the group, and nₘₐₓ is the number of messages the user has sent to the group that the user has used most frequently.
g₃ is the recency of last use of the group,
   g₃=Φ₁₅(n)
where n is the number of days since the group was last used by the user.

H. Rich Content Distribution

The present invention also provides a technique for communicating complex content from a first party mobile user to a second party, which may be a mobile or non-mobile user. Referring back to FIG. 1, the gateways 120a-120b are configured to communicate with mobile devices 130a-130b and to forward communication over a network. The server 110 contains content in the database 112 and is coupled over the network to the gateways 120a-120b, and adapted to receive calls from the mobile devices 130a-130b to forward content to one or more parties. In this context, “calls” are not necessarily telephone voice calls, but also include Internet protocol requests and calls between the mobile devices 130a-130b and the server 110.

FIG. 2 illustrates a server architecture 200 demonstrating the message flow in accordance with one embodiment of the present invention. When a first party mobile device 130a user wants to share an application or program with a second party, the first party forwards information to the second party. The second party can be a mobile or non-mobile user. The exemplary content may be rich content, for example, ring tones, wall paper, mobile games, phone applications and even more complex programs and games. The application servers 230 retrieve the content from a database 250 and forward the content to the second party. In some cases, the application server 230 may pass a link to the content rather than the content.

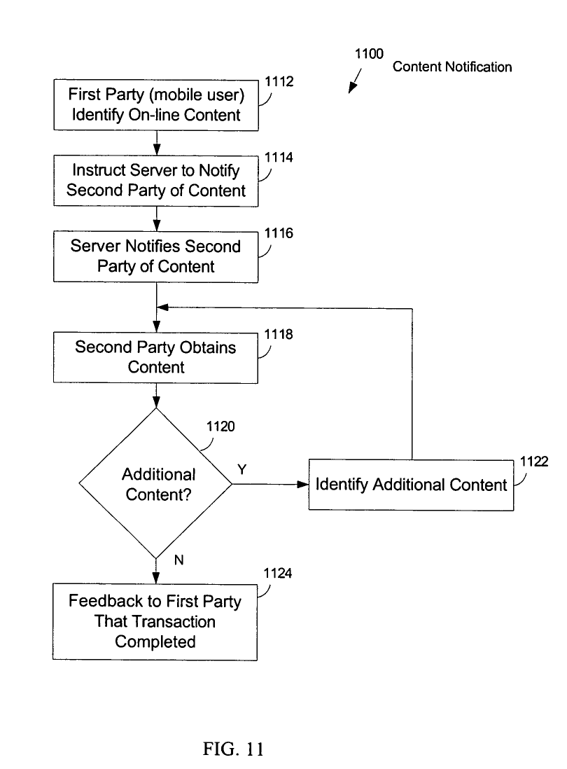

FIG. 11 is a flowchart 1100 illustrating one approach of processing a content notification message to a second party in accordance with the present invention. In step 1112, a first party (mobile user) identifies desired content to forward to a second party. In step 1114, the first party instructs the server to notify the second party of the content. In step 1116, the server notifies the second party of the content. In step 1118, the second party obtains the content. In one aspect, the server sends the content to the second party. In another aspect, the server provides a link for the second party to obtain the content. In step 1120, the server determines whether there is additional content to send. If so, step 1122 identifies the additional content and returns the method to step 1118 for the second party to obtain the additional content. In step 1120 is no, step 1124 provides feedback to the first party that the transaction is completed.

In practice, the invention can be used to send content for free or for payment. The content can represent a number of things including ring tones, software and games and the like, but can also include more tangible things like gift certificates and other similarly tangible content. In one aspect, a user can purchase the content and then forward it to another party as a gift to be redeemed by the second party. The receiver may be able to then play a game, listed to a song, obtain a gift certificate, or other perform another action by virtue of the content sent to that person.

An additional aspect of the invention is that content can be distributed to multiple parties simultaneously similar to sending a message to multiple parties. For example, a user may have a group of people who he wants to send content and that content will be sent to each member of the group. This is performed in a manner similar to the technology described above.

I. Conclusion

Advantages of the invention include the ability to communicate rich content to other users including ring tones, wall paper, mobile games, phone applications and even more complex programs, games and other content.

Having disclosed exemplary embodiments and the best mode, modifications and variations may be made to the disclosed embodiments while remaining within the subject and spirit of the invention as defined by the following claims.

1. A mobile messaging platform for communicating among a plurality of wireless devices comprising:
at least one gateway configured to communicate with mobile devices and to support communication over a network; and
a server coupled over the network to the gateway, and adapted to receive a single message from a first party using a mobile device to forward the message to at multiple second parties.

2. The mobile messaging platform of claim 1, wherein:
the message includes information regarding the second parties.

3. The mobile messaging platform of claim 1, wherein:
the message includes identification information regarding the second parties, which identification information is stored on the server and associated with a delivery address.

4. The mobile messaging platform of claim 3, wherein:
the identification information alone is insufficient to delivery the message.

5. The mobile messaging platform of claim 3, wherein:
the second parties are members of a group identified in a record associated with the first party.

6. The mobile messaging platform of claim 1, wherein:
the server is adapted to receive a single message from a first party using a mobile device to forward the message to multiple second parties using mobile devices.

7. The mobile messaging platform of claim 1, wherein:
the message is a Short Message Service (SMS) message; and
the server is a Short Message Service Center (SMSC).

8. The mobile messaging platform of claim 7, wherein:
the server is adapted to receive a single message from a first party using a mobile device to forward the message to multiple second parties using mobile devices.

9. The mobile messaging platform of claim 1, wherein:
the server contains content; and
the message includes rich content.

10. A mobile messaging platform for communicating among a plurality of wireless devices comprising:
at least one gateway configured to communicate with mobile devices and to support communication over a network; and
a server containing content and coupled over the network to the gateway, and adapted to receive a single message from a first party using a mobile device to forward content to at least one other second party.

11. The mobile messaging platform of claim 10, wherein:
the content includes rich media.

12. The mobile messaging platform of claim 10, wherein:
the content includes ring tones, wall paper, mobile games, phone applications and more complex programs and games.

13. The mobile messaging platform of claim 11, wherein:
the content includes ring tones, wall paper, mobile games, phone applications and more complex programs and games.

14. The mobile messaging platform of claim 10, wherein:
the server is configured to distribute the content to multiple second parties.

15. The mobile messaging platform of claim 11, wherein:
the server is configured to distribute the content to multiple second parties.

16. The mobile messaging platform of claim 10, wherein:
the message is a Short Message Service (SMS) message; and
the server is a Short Message Service Center (SMSC).

17. A method of communicating messages from a first party using a mobile device to multiple second parties, using at least one gateway and a server coupled over the network to the gateway, comprising the steps of:
receiving a single message from a first party using a mobile device; and
forwarding the message to multiple second parties.

18. The method of claim 17, wherein:
the message includes information regarding the second parties.

19. The method of claim 17, wherein:
the message includes identification information regarding the second parties, which identification information is stored on the server and associated with a delivery address.

20. The method of claim 19, wherein:
the identification information alone is insufficient to delivery the message.

21. The method of claim 19, wherein:
the second parties are members of a group identified in a record associated with the first party.

22. The method of claim 17, wherein:
the receiving step includes the server receiving a single message from a first party using a mobile device; and
the forwarding step includes the server forwarding the message to multiple second parties using mobile devices.

23. The method of claim 17, further comprising:
confirming receipt of the message received by the second parties.

24. The method of claim 17, further comprising the step of:
sorting the messages; and
sorting information regarding the second parties.

25. The method of claim 23, further comprising the step of:
storing the messages in a log file.

26. The method of claim 17, wherein:
the message is a Short Message Service (SMS) message; and
the server is a Short Message Service Center (SMSC).

27. The method of claim 17, wherein:
the server contains content; and
the message includes rich content.

28. A method of communicating messages from a first party using a mobile device to multiple second parties, using at least one gateway and a server containing content coupled over the network to the gateway, comprising the steps of:
receiving a single message from a first party using a mobile device; and
forwarding content to at least one second party.

29. The method of claim 28, wherein:
the content includes rich media.

30. The method of claim 28, wherein:
the content includes ring tones, wall paper, mobile games, phone applications and more complex programs and games.

31. The method of claim 28, wherein:
the forwarding step including distributing the content to multiple second parties.

32. The method of claim 29, wherein:
the forwarding step including distributing the content to multiple second parties.

33. The method of claim 28, further comprising the step of:
sorting the messages; and
sorting information regarding the second parties.

34. The method of claim 28, further comprising the step of:
confirming receipt of the message received by the second parties.

35. The method of claim 33, further comprising the step of:
storing the messages in a log file.

36. The method of claim 28, wherein:
the message is a Short Message Service (SMS) message; and
the server is a Short Message Service Center (SMSC).
